(19) United States
(12) Patent Application Publication
(10) Pub. No.: US 2017/0335674 A1
(43) Pub. Date: Nov. 23, 2017

(54) Detector Configuration For Well-Logging Tool

(71) Applicant: Halliburton Energy Services, Inc., Houston, TX (US)

(72) Inventor: David James Laban, Bishop's Cleeve (GB)

(21) Appl. No.: 15/520,927

(22) PCT Filed: Dec. 29, 2014
(86) PCT No.: PCT/US2014/072536

§ 371 Date: Apr. 21, 2017

(51) Int. Cl. E21B 47/01; G01V 1/52

(52) U.S. Cl. CPC E21B 47/01; G01V 1/52

(57) ABSTRACT

In a logging tool, a plurality of detectors (such as, e.g., a plurality of scintillation detector assemblies each including a scintillation crystal and associated photomultiplier tube) may be individually pressure-encased and arranged about a longitudinal axis of the tool, leaving a flow space between the detectors for the flow of drilling mud or other fluid through the tool. In some embodiments, this arrangement allows increasing the volume of detector material (e.g., scintillation crystal) without compromising the total cross-sectional area of the flow space (or increasing the total cross-section area without reducing the volume of detector material), compared, e.g., with tool configurations in which a single pressure case encloses the detectors. Additional apparatus, systems, and methods are disclosed.

### BACKGROUND

Fluids (e.g., oil, water, gas) trapped in geologic formations are often recovered via a well, or borehole, drilled into the formation. A drilling operation generally utilizes a drill string including a plurality of drill pipe segments or “joints” connected end to end suspended from the surface facility, with a bottom-hole assembly (BHA), including a drill bit, attached at the lower end. Drilling mud may be circulated through the drill pipe, BHA and included drill bit, and an annulus formed between the drill string and borehole wall to cool the drill bit and carry drill cuttings back up to the surface. During drilling, it is often desirable to monitor the properties of the borehole and surrounding formation and fluids, for instance, to guide borehole placement so that the borehole remains within or reaches the zone of interest, or to adjust drilling parameters (such as the drilling speed, size of the drill bit, composition of the drilling mud, etc.), e.g., to ensure the mechanical integrity of the borehole. For this purpose, well logging tools may be integrated into the BHA, acquiring data in real time (or near real time) at increasing borehole depths as the drill bit advances (a technique known in the industry as “logging while drilling” (LWD) or “measuring while drilling” (MWD), which are hereinafter used synonymously). Alternatively, measurements may be taken after a certain borehole section has been drilled, using a logging tool lowered into the borehole on a wireline cable (a techniques known as “wireline logging”). Both techniques often use a tool string with multiple different logging tools to measure various electric, mechanical, or sonic formation or borehole properties, nuclear radiation emanating from the formation, borehole dimensions, etc.

For various logging tools, signal strength and/or quality (e.g., signal-to-noise ratio) depend on the volume of sensor material utilized. For example, gamma-ray tools may employ scintillation crystals that produce flashes of light in response to the absorption of gamma radiation (e.g., high-energy photons) emitted from the formation, in conjunction with photomultipliers that convert the flashes of light into quantifiable electrical pulses proportional to the energy of the absorbed particle. Based on measurements of the energy and quantity of gamma particles emitted from the formation, gamma-ray tools can distinguish between different types of rock (e.g., sandstone and limestone), and thereby ascertain where the tool is within the formation. The quality of readings provided by gamma-ray tools can generally be improved by increasing the total crystal volume in the tool (e.g., in an array of sensors, the crystal volume per sensor and/or the number of sensors). However, given the spatial confines of well-logging tools, increasing the sensor presence within the tool often compromises other design considerations and parameters. These considerations include the desire to obtain higher pressure ratings (which are generally achieved with thicker casings), to reduce the velocity of fluids (e.g., drilling mud or other abrasive fluids) through the tool to prolong component life by reducing erosion rates (which can be achieved by providing larger flow channels through the tool), and to minimize the overall tool dimensions. All of these criteria compete with the desire to increase sensor volume.

### BRIEF DESCRIPTION OF THE DRAWINGS

FIG. 1 is a schematic diagram of an example drill string and BHA including a well-logging tool for MWD/LWD operations, in accordance with various embodiments.

FIG. 2 is a cutaway view of a logging tool including four scintillation detector assemblies (SDAs) inside a BHA, in accordance with one embodiment.

FIG. 3A is a cross-sectional view of the electronics module of the logging tool of FIG. 2.

FIG. 3B is a cross-sectional view of the sensor portion of the logging tool of FIG. 2.

FIGS. 4A-4C are cross-sectional views of alternative sensor arrangements within a housing, in accordance with various embodiments.

FIG. 5 is a flow chart of an example MWD/LWD operation in accordance with various embodiments.

### DESCRIPTION

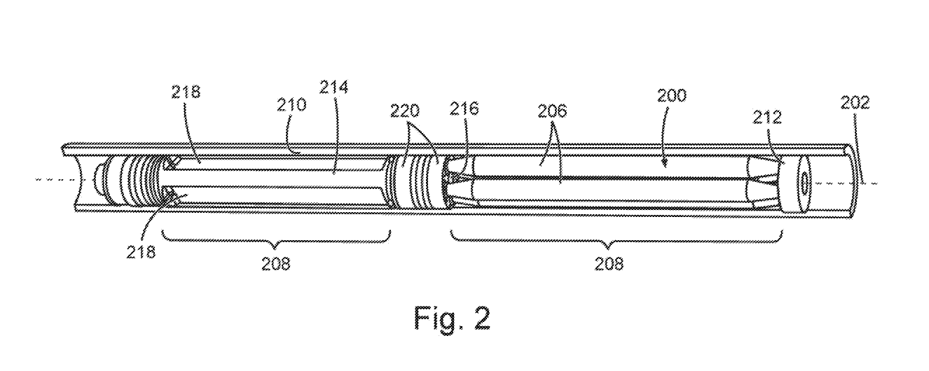

Disclosed herein, in accordance with various embodiments, is a logging-tool configuration in which multiple detectors are individually pressure-encased and arranged substantially parallel (e.g., at an angle of less than 5°, and more often, less than 1°) to the tool axis and laterally adjacent to one another inside a tubular housing (such as a drill collar in MWD/LWD embodiments, or a tool body in wireline embodiments). The phrase “laterally adjacent” means that the detectors overlap in their longitudinal positions along the tool axis such that the transverse cross-sections of the tool (i.e., cross-sections perpendicular to the tool axis) are, within a certain longitudinal portion of the tool, intersected by all of the detectors, at different cross-sectional locations. For example, in some embodiments, the detectors are of substantially equal lengths and arranged with their ends flush with one another, their respective axes intersecting one or more concentric circles in a cross-section of the tool. (This arrangement is shown in FIG. 2.) Advantageously, individually encasing the detectors leaves room between the detectors for the passage of fluid, increasing the overall flow cross-section—compared with various conventional designs where detectors of comparable dimensions are encased collectively (e.g., in an annular configuration), as explained in more detail below—and/or allowing the detector dimensions to be increased without reducing the flow cross-section. Thus, for a given inner diameter of the tool housing and a given total flow cross-section, the present configuration increases the total cross-sectional area available for the sensor material, allowing for a larger quantity and volume of sensor material within a given length of drill pipe.

In the following description, scintillation detector assemblies used in gamma-ray tools are described. The principles and features described herein can, however, be practiced with other types of detectors and tools, and are applicable to any kind of detectors in which the sensor itself takes up a relatively large amount of space, compared with the overall size of the tool (which may include other detector components, electronic circuitry, power supplies, etc.). Furthermore, the configuration described herein may be applicable to other tool components that benefit from a larger volume, such as, e.g., batteries, whose capacity may be increased by increasing battery volume.

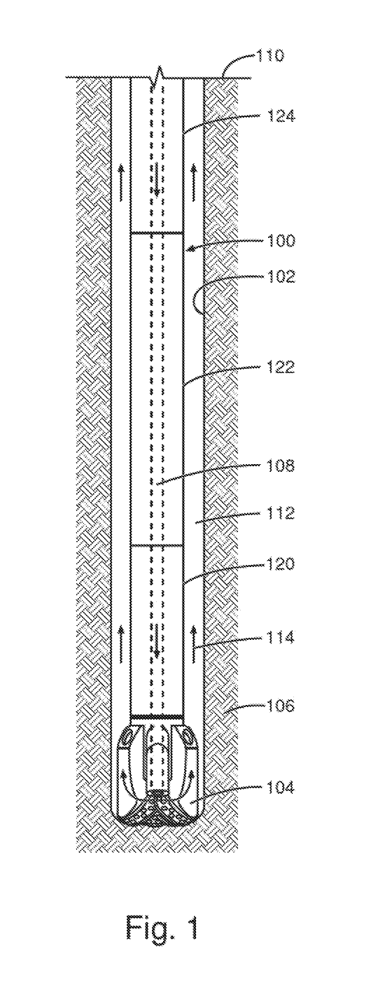

Referring initially to FIG. 1, a schematic side view of a BHA 100 of a drill string disposed in a borehole 102 is shown. The BHA 100 includes a drill bit 104 for drilling the borehole 102 in an earth formation 106. Through a flow bore 108 extending axially through the drill string, drilling fluid flows from the surface 110 downward toward and out through the drill bit 104. The drilling fluid then returns to the surface via an annulus 112, as shown by the flow path 114. The BHA 100 may include, in addition to the drill bit 104, drill collars 120, 122, 124, a directional drilling device (e.g., a mud motor or steerable system), stabilizers (located anywhere within the BHA 100), and LWD/MWD tools and components. The drill collars are often formed as thick-walled tubular sections of (often steel) pipe that serve to apply weight on the drill bit 104; multiple collars can be screwed together via threaded connections. Drill collars may have other components, such as logging tools, telemetry devices, circuitry, power cables, directional drilling devices, etc. integrated therein. Short drill collars, when integrated with such other tools and devices, are often referred to as “subs.” A directional drilling device is, in many embodiments, integrated into a drill collar close to the drill bit 104 (such as drill collar 120). In various embodiments, the LWD/MWD tools and components are likewise placed close to the drill bit 104. For example, they may form an integral part of the directional device within drill collar 120, or be integrated with or inserted into a drill collar 122 immediately above the directional device to form a separate sub. In general, logging tools can be located in any section of the BHA 100.

A drill collar including an MWD/LWD assembly is only one way of conveying a logging tool in accordance herewith into a borehole. Alternatively, the detector, circuitry, and other tool components may be contained inside a longitudinal tool body conveyed downhole using other apparatus. For example, the tool body may be run into the borehole at the end of a wireline that is operated by a winch. In addition to providing the mechanical support for the tool string, the wireline may supply the tools with electricity and transmit data from the tools to a surface processing facility. The tool body is configured to withstand the pressure and temperature conditions expected in the well.

FIG. 2 illustrates a well-logging tool 200 according to one embodiment in a cutaway perspective view. The tool 200 includes two portions arranged adjacent to one another (or “end-to-end”) along a longitudinal axis 202: a detector module 204 including a plurality of encased detectors 206 (hereinafter also referred to as a “sonde array”), and an electronics module 208 including associated control- and processing circuitry and power supplies. The sonde array 204 and electronics module 208 are contained within, and span the inner diameter of, a tubular housing or sleeve 210.

In MWD embodiments, as illustrated for instance in FIG. 1, the housing 210 may comprise a drill collar (e.g., collar 122) or portion thereof, and the tool 200 and collar together may form one of the subs of the BHA 100. The tool 200 may be connected to other tools via connectors 212 at one or both ends. In wireline embodiments, the housing 210 may be formed by the tool body, which may also contain additional logging tools. Thus, the housing 210 may be provided as part of an assembly used in logging operations, or as part of a separate system component (as in the case of the drill collar).

Unless specifically designated otherwise herein, where reference is made to the logging tool 200, the housing 210 is not deemed to be part of the tool. Accordingly, the diameter of the tool 200 corresponds to the largest transverse cross-sectional dimension of the sonde array 204, electronics module 208, and/or connectors 212, 220, which is no greater than the inner diameter of the housing 210. In various embodiments, the diameter of the detector module 204 (e.g., the diameter of a circle circumscribing the encased detectors 206) substantially equals (e.g., within a margin of error of 5% or 1%) the inner diameter of the housing 210 (and, with the depicted configuration of the electronics module 208, thereby also the outer diameter of the electronics module 208).

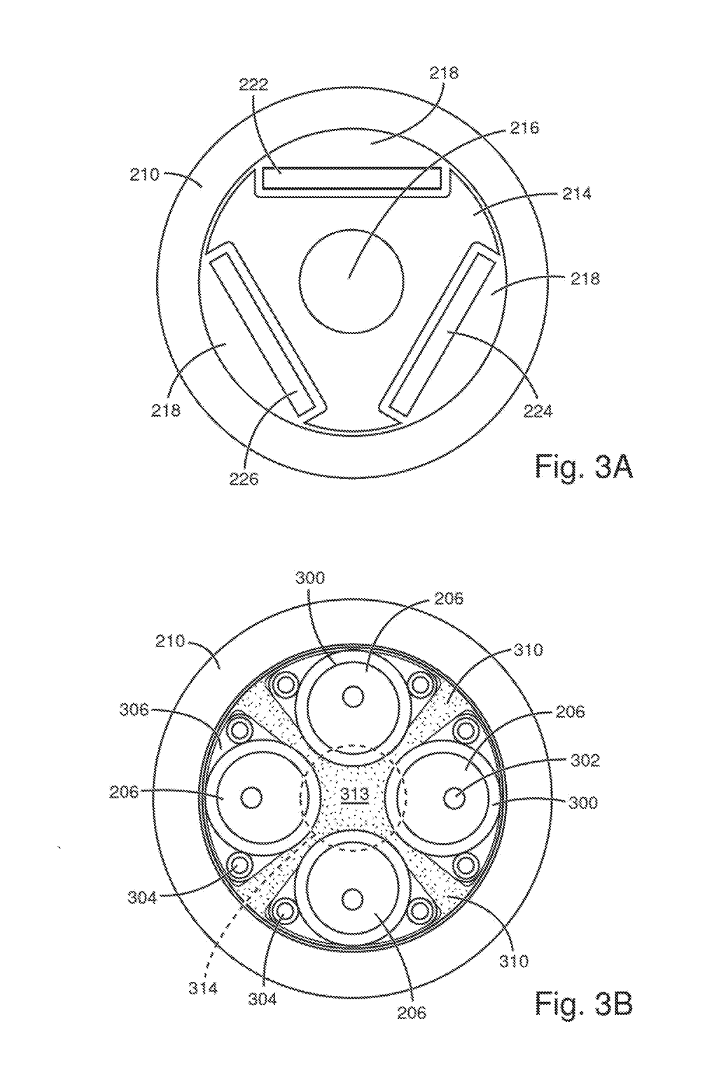

In some embodiments, the sonde array 204 includes four encased detectors 206 in a parallel arrangement. The detectors may be, for example, SDAs, each including a scintillation crystal (the “sensor material”) and associated photomultiplier tube, usually placed end-to-end along the longitudinal detector axis (which is parallel to the tool axis 202). In some embodiments, the detectors also include some electronic circuitry, such as an electronic pulse amplifier, and/or a small power supply, although the larger part of the circuitry and power supplies is generally contained in the electronics module 208. Each detector is separately enclosed in a pressure case suitable for resisting the specified tool pressure. In some embodiments, the encased detectors 206 (and the tool 200 as a whole) are pressure-rated for 10,000 psi or more. For example, in one embodiment, a pressure rating of 20,000 psi is achieved with a pressure case that is 0.14″ thick. The open space between the encased detectors 206 (illustrated more clearly in FIG. 3B) forms a contiguous “flow space” or “flow channel” through which drilling mud or other fluids can flow from one longitudinal end of the sonde array 204 (e.g., at 220) to the other end (e.g., at 212).

The electronics module 208, depicted in cross-sectional view in FIG. 3A, may include a longitudinal insert chassis 214 with a central, longitudinal bore 216 along its longitudinal axis that provides a flow channel for drilling mud and/or other fluids. The insert may include a number of pockets 218 into which various electronics boards 222, 224, 226 can be mounted. For example, in some gamma-ray tool embodiments, the electronics module 208 includes an azimuthal processor board that determines the rotational position of the sonde array, a spectral gamma board that processes data received from the detectors, and a power supply board, which are mounted in three pockets positioned, e.g., at 120° intervals around the insert 214. The insert 214 and the boards 222, 224, 226 mounted therein are sealed from the (drilling) fluid at both ends. Alternatively to providing an insert 214 with a central bore 216, the electronics module 208 may be placed within an additional pressure case along the axis 202 of the tool 200 (suspended inside the housing 210, e.g., by radial struts) and leave an annular flow channel. Other configurations of the electronics module 208 are also possible and may be used in conjunction with a sonde array in accordance herewith, provided that the flow channels of the sonde array and electronics module 208 are fluidically coupled. Regardless of the specific configuration of the electronics module 208, electrical connection and communication between the sonde array 204 and the electronics module 208 may be established via a solid connector (or pair of connectors) 220, as shown, or via direct wiring. In some embodiments, the electrical connection includes a high-voltage line (e.g., for about 1500 Volts) for providing power to the pulse amplifiers that may be contained in the individual encased detectors 206 of the sonde array 204. In alternative embodiments, suitable power-supply modules may be integrated directly with the pulse amplifiers in the sonde array 204.

FIG. 3B provides a cross-sectional view through the sonde array 204 of the logging tool 200. Herein, the location of the encased detectors 206 is indicated by means of their surrounding tubular (and, in cross-section, circular) pressure cases 300 and the wire routings 302 of the power and/or signal-carrying cables extending from the photomultiplier tubes (which are, in the illustrated example, slightly offset from the center of the encased detectors 206). The encased detectors 206 may be attached to threaded flange components 306, which, in turn, may be bolted (using bolts 304) or otherwise attached to the electronics module 208 and/or longitudinally adjacent logging tools, e.g., via the connectors 220, 212. Other ways of affixing the encased detectors 206 will readily occur to those of ordinary skill in the art.

As shown, the encased detectors 206 may be placed inside the collar or other housing 210 in contact with (or at least proximate to) the interior surface of the housing. The spaces 310 between adjacent ones of the detectors 206 and the central space between the four detectors 206 collectively form a contiguous flow space (or, when viewed between the two longitudinal ends of the sonde array 204, a flow channel) 313 (indicated by the dot pattern). For comparison, the dashed line 314 indicates the periphery of the flow bore in a conventional configuration of the detector module in which detectors of similar dimensions are enclosed in an annular insert. As can be seen, the total flow-channel area in the instant embodiment is greater than that of the central circular flow bore in a conventional annular-insert configuration.

To quantify the difference in capability, assume that the inner diameter of the collar 210 is 3.656 inches (which is a dimension used in various industrially-deployed collars, such as those used in 4.75-inch-class tools), corresponding to a cross-section of about 10.50 square inches. Further assume that, in a conventional tool for use in such a collar, the diameter of the flow bore is 1.25 inches, corresponding to a flow cross-section of 1.23 square inches, or about 12% of the total inner cross-sectional area of the collar. By contrast, four individually encased SDAs with outer diameters (referring to the outer diameters of the pressure cases) of 1.375 inches (which allows for a diameter of the scintillating crystal within each pressures case of about 0.745″, amounting to a total scintillator cross section of about 1.74 square inches, which is comparable with conventional tools with a central flow bore) take up a total cross-sectional area of 5.94 square inches, leaving a flow-channel area of 4.56 square inches, or about 43% of the total inner cross-sectional area of the collar. In various embodiments, the cross-sectional are of the flow space 313 is at least 20%, in some embodiments at least 40%, of the total cross-sectional area of the tool 200 (which is deemed to not include the housing 210).

The flow channel 313 through the sonde array 204 is fluidically coupled to the longitudinal bore 216 through the electronics module 208. For example, the longitudinal bore 216 may simply be extended through the connectors 220 with uniform diameter. If the longitudinal bore 216 through the electronics module 208 has the same dimensions as the longitudinal bore through a conventional insert with annular distribution of the detectors (i.e., dimensions corresponding to periphery 314), the electronics module 208 becomes the flow-volume-limiting factor for fluid flow through the tool 200. However, the electronics module 208 can generally be re-designed straightforwardly to increase the diameter of its longitudinal bore (within certain limits). Accordingly, an arrangement of individually encased detectors 206 in accordance herewith facilitates an increase in the flow-channel area throughout the entire length of the logging tool 200, and thus a decrease in the velocity of fluid flow at a given flow rate (measured in fluid volume per unit time).

In many deployment contexts, flow rates through a 4.75-inch conventional tool with a central bore of 1.25 inches in diameter (and a cross-section of 1.227 square inches) are between 150 and 350 gallons per minute, corresponding to flow velocities between 39.2 and 91.5 feet per second. If the flow cross-section is, instead, 4.558 square inches, e.g., in accordance with the sonde array configuration depicted in FIGS. 2 and 3, flow velocities for the same range of flow rates are decreased to 10.6 to 24.6 feet per second, i.e., by a factor of almost four. Larger tools usually run at higher mud flow rates, but also have larger flow areas. For instance, a 6.75-inch tool with a 1.92-inch-diameter central bore may be used at flow rates of up to 650 gallons per minute, corresponding to flow velocities of up to 72.03 feet per second, and an 8-inch-tool with a 2.375-inch-diameter bore may be used at up to 1200 gallons per minute, corresponding to flow velocities of up to 86.9 feet. In these cases, flow velocities may similarly be reduced by changing the sonde array configuration from an annular tool with a single central bore to individually encased detectors that leave a larger cross-sectional area available for fluid flow.

Lower fluid velocities can reduce abrasion on various components of the drill string, including the logging tool itself, thereby potentially increasing the lifetime of these components. Further, lower fluid velocities reduce the pressure drop across the system, such that a higher pressure will be available at the bit, improving drilling performance. In various embodiments hereof, flow velocities are kept to 50 feet per second or less without compromising flow rates.

Alternatively or additionally to increasing the flow area in a tool of a given diameter, embodiments hereof facilitate increasing the cross-sectional area (and thus the volume) occupied by the sensor material, such as a scintillation crystal (in SDAs). For example, the sonde array configuration of FIGS. 2 and 3B allows increasing the diameter of each pressure case from 1.375 inches to about 1.5 inches without comprising the flow velocities and flow rates through the tool. This increase in the detector diameter may results in a gain of about 36% in sensor volume, which can significantly improve the received signal quality. In various example embodiments, the total volume of scintillation crystal (or other radiation-sensitive material) in the tool is at least about 15.31 cubic inches (e.g., provided by four 3.83-cubic-inch detectors). For comparison, the total volume of sensor material in a conventional insert configuration with annular distribution of the detectors is only about 11.24 cubic inches.

It should be understood that the various dimensions and quantities provided in the above examples serve merely to illustrate various improvements that might be achieved with sonde array configurations made in accordance with the information provided herein, in particular, through the separate encasings of individual detectors. Those of ordinary skill in the art will know, after reading the detailed information provided by this document, how to adjust the tool dimensions for tools of overall larger or smaller dimensions and/or for different operational conditions (e.g., different requirements on flow rates and flow velocities, different pressures, etc.) Furthermore, it will be readily apparent to those of ordinary skill in the art that the benefits described herein are not necessarily contingent upon separately encasing each and every individual detector, but may also be realized, at least in part, if multiple groups of detectors within a logging tool each receive their own pressure case. Accordingly, where the present disclosure references a “detector” (in the singular), this term is not meant to exclude an assembly having multiple detector components of the same kind (e.g., multiple crystals, multiple photomultiplier tubes, etc.).

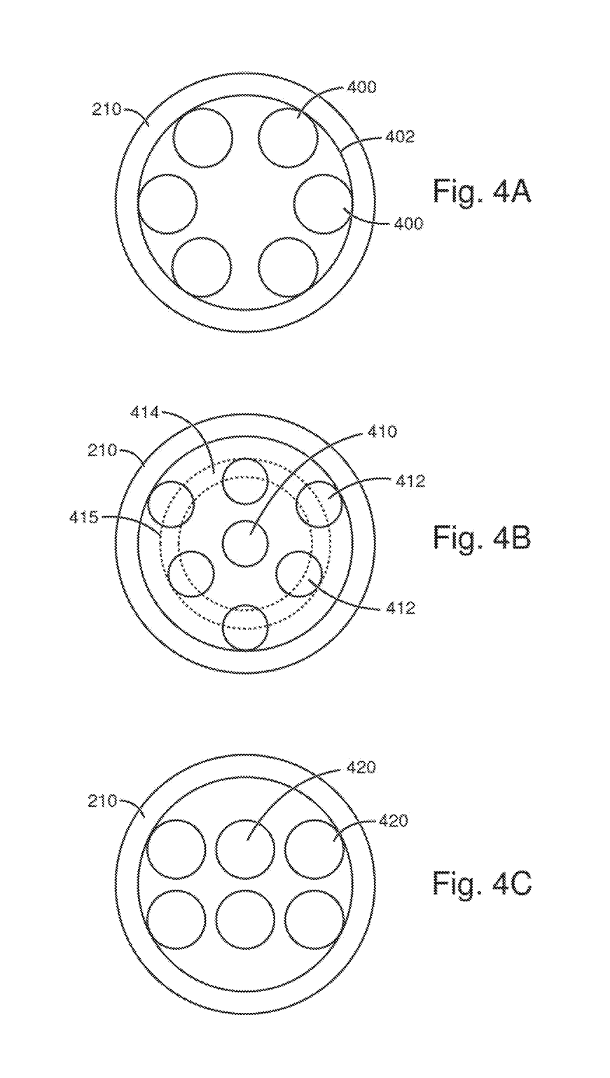

Furthermore, it will be readily appreciated that the particular sonde array configuration shown in FIGS. 2 and 3B is merely one example, and that many other configurations implementing the principles disclosed herein are possible. FIGS. 4A-4C provide, in cross-sectional views of the sonde array tool (similar to FIG. 3B), a few examples of such alternative configurations. In general, the sonde array can include fewer or more than four detectors (as long as there are at least two separately encased detectors); FIG. 4A shows an example in which six individually encased detectors 400 are arranged along the inner circumference 402 of the collar 210. Further, the detectors need not all be arranged with their centers on a single circle centered on the axis, but may be placed along multiple concentric circles. As fluid can flow through the sonde array in spaces between the detectors, a detector may also be placed at the central axis of the sonde array. For example, the embodiment shown in FIG. 4B includes a central detector 410 surrounded by six additional detectors 412 arranged along two concentric circles 414, 415. Moreover, the detectors need not be positioned along concentric circles at all, but may be arranged in any kind of regular or irregular array; an example of six detectors 420 arranged in two rows is shown in FIG. 4C. While a certain degree of radial symmetry about the longitudinal axis may be advantageous, e.g., for weight-balancing or consistency in the fluid flow, there is generally no stringent requirement on the placement of the tools. It should also be noted that the various detectors may, but need not, have uniform dimensions. For various measurement applications, a detector arrangement as shown in FIG. 3B or 4A, where the detectors all have the same radial position within the array, may be beneficial because the uniform radial positions enable consistent readings from the formation and consistent azimuthal responses.

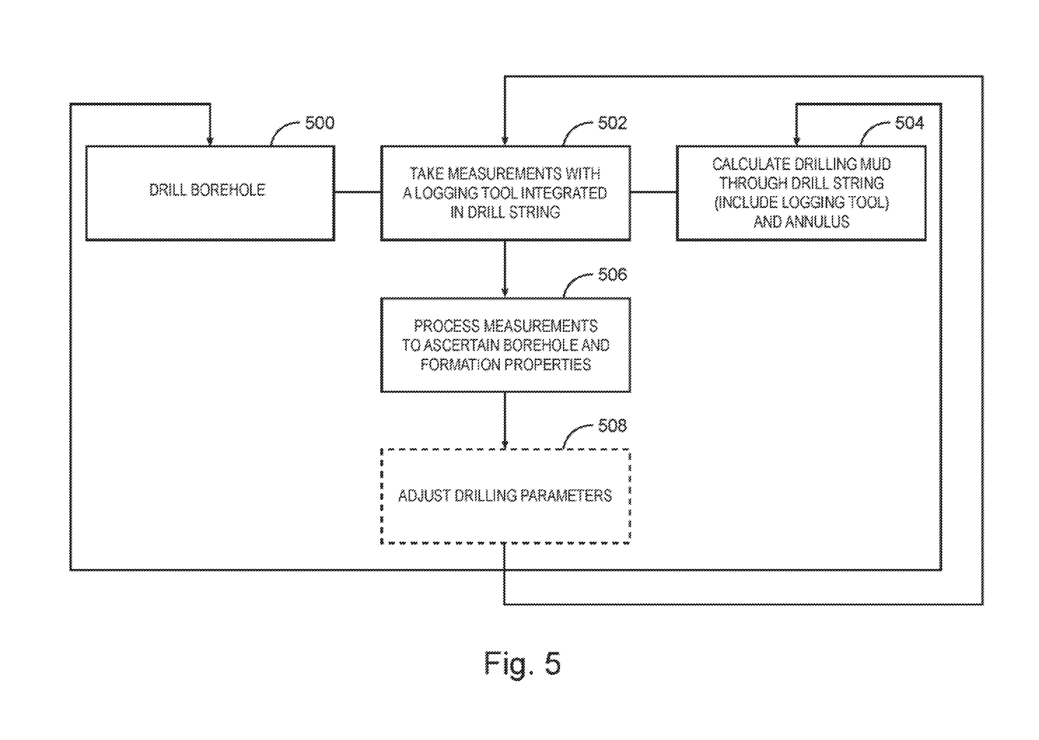

Turning now to the use of the logging tools in accordance herewith, FIG. 5 illustrates an example drilling method including an MWD/LWD operation. The method involves drilling a borehole (action 500) with a drill bit (e.g., bit 104 of FIG. 1) attached at the end of a drill string and, while drilling, taking measurements (action 502) with a logging tool (e.g., tool 200 of FIGS. 2 and 3) that is integrated in the drill string (e.g., placed inside a drill collar of the BHA 100). The logging tool includes a plurality of detectors arranged about an axis of the tool (which generally coincides with an axis of the drill string) and leaving a flow channel for the flow of fluid through the tool. During drilling, a mud pump circulates drilling mud through the drill string (including the flow channel of the logging tool), out the drill bit, and back up to the surface through the borehole annulus (action 504). Operation of the mud pump can be adjusted to control the rate at which the mud is circulated. In various embodiments, the drilling mud is caused to flow through the logging tool at a flow rate of at least 100 gallons per minute, but a flow velocity of no more than 60 feet per second; limiting the flow velocity in this manner is facilitated by providing the logging tool with a flow channel of sufficiently large cross-sectional area (i.e., a cross-sectional area equal to or exceeding the ratio of the minimum flow rate to the maximum flow velocity). This sufficiently large flow-channel area, in turn, is achieved in accordance herewith without comprising the volume of radiation-sensitive detector material by pressure-encasing each detector individually.

The measurements are processed to ascertain borehole and formation properties (action 506). For example, the logging tool may comprise a gamma-ray tool that uses an array of SDAs as detectors to facilitate the detection of nuclear radiation emanating from the surrounding formation. The detector signals may be processed, e.g., by a spectral-gamma processing board included in the tool, to quantify the radiation. Further, an azimuthal processing board of the tool may determine the rotational position of the tool at the time each measurement was taken, allowing the radiation to be measured directionally. Based on the borehole and formation properties as inferred from the processed measurements, parameters of the drilling operation may then be adjusted (action 508). For example, if the formation properties deviate from those expected, indicating that the location of the borehole relative to the formation is not correct, the drilling direction may be changed (e.g., using the directional device 120).

Many variations may be made in the structures and techniques described and illustrated herein without departing from the scope of the inventive subject matter. Accordingly, the scope of the inventive subject matter is to be determined by the scope of the following claims and all additional claims supported by the present disclosure, and all equivalents of such claims.

What is claimed is:

1. A logging tool comprising:
a sonde array comprising a plurality of detectors arranged substantially parallel to a longitudinal axis of the tool, each detector being individually encased in a pressure case as an encased detector; and
adjacent, along the longitudinal axis, to the sonde array and electrically connected with the detectors, an electronics module comprising a processor board for processing data received from the detectors.

2. The tool of claim 1, wherein the detectors comprise scintillation detector assemblies.

3. The tool of claim 1, wherein the electronics module defines a longitudinal bore therethrough.

4. The tool of claim 3, wherein the longitudinal bore is fluidically coupled to a flow space between the encased detectors.

5. The tool of claim 4, wherein a total cross-sectional area of the flow space between the encased detectors is no smaller than a cross-sectional area of the longitudinal bore through the electronics module.

6. The tool of claim 1, wherein a total cross-sectional area of the flow space between the encased detectors is at least 20% of a total cross-sectional area of the tool.

7. The tool of claim 1, wherein a total cross-sectional area of the flow space between the encased SDAs is at least 40% of a total cross-sectional area of the tool.

8. The tool of claim 1, wherein the detectors are arranged along a circle centered on the axis.

9. The tool of claim 1, wherein the SDAs are arranged along multiple concentric circles centered on the longitudinal axis.

10. The tool of claim 1, wherein the SDAs comprise an SDA centered on the longitudinal axis.

11. The tool of claim 1, wherein the array consists of four SDAs.

12. The tool of claim 1, wherein a diameter of a circle circumscribing the sonde array is substantially equal to an inner diameter of a housing of the tool.

13. The tool of claim 1, wherein the tool is pressure-rated for at least 10,000 psi.

14. The tool of claim 1, wherein the electronics module is electrically connected with the detectors by wiring.

15. The tool of claim 1, wherein the electronics module is electrically connected with the detectors via a solid connector.

16. The tool of claim 1, wherein the electronics module further comprises a power-supply board and an azimuthal processor board for determining a rotational position of the sonde array.

17. A logging-while-drilling system, comprising:
a drill string comprising a drill collar and a drill bit; and
contained inside the drill collar and configured to rotate therewith, one or more logging tools, each of the logging tools comprising an array of detectors arranged substantially parallel to a longitudinal axis of the tool, each detector being individually encased in a pressure case as an encased detector, and an electronics comprising a processor board for processing data received from the detectors, the electronics module disposed along the longitudinal axis of the tool.

18. A method, comprising:
drilling a borehole with a drill bit suspended from a drill collar; and
while drilling,
measuring radiation with a logging tool disposed inside the drill collar, the tool including an array of individually pressure-encased detectors arranged about a longitudinal axis of the drill collar substantially parallel thereto; and
causing drilling mud to flow through the tool via open space between the encased detectors.

19. The method of claim 18, wherein the drilling mud is caused to flow through the tool at a flow rate of at least 100 gallons per minute and a flow velocity of no more than 60 feet per second.

20. The method of claim 19, wherein the detectors comprise scintillation detector assemblies collectively including a volume of radiation-sensitive material of no less than 6.5 cubic inches, and wherein the measuring comprises receiving radiation with the radiation-sensitive material.

21. The method of claim 18, wherein the logging tool further comprises an electronics module including a processor board for processing data received from the detectors, the method further comprising using the processor board to process the data in a sequence over the array of detectors.

22. The method of claim 21, further comprising adjusting a drilling parameter based on the processing.
